(19) United States
(12) Patent Application Publication
(10) Pub. No.: US 2026/0099070 A1
(43) Pub. Date: Apr. 9, 2026

(54) Optical Bonding Process and LCD Panel Produced

(71) Applicant: Computer Express, LLC, Berlin, CT (US)

(72) Inventor: Michael Psillas, Berlin, CT (US)

(21) Appl. No.: 19/348,043

(22) Filed: Oct. 2, 2025

Related U.S. Application Data
(60) Provisional application No. 63/703,305, filed on Oct. 4, 2024.

(51) Int. Cl. G02F 1/1333

(52) U.S. Cl. CPC G02F 1/133325; G02F 1/133305; G02F 1/133314; G02F 1/133331; G02F 1/13338; G02F 1/133388

(57) ABSTRACT

Liquid crystal displays (LCDs) and methods of making LCDs are provided where a layered stack of components is secured with at least one piece of tape, such as black mylar tape. The layered stack is bonded to a cover glass and optionally a touch panel/sensor with an optically clear adhesive (OCA). Methods and apparatuses include at least one piece of tape secured to a front side of the layered stack such that the at least one piece of tape folds over the perimeter of the layered stack and is secured to a rear side of the layered stack.

### CROSS REFERENCE TO RELATED APPLICATION

The present application claims priority to U.S. Provisional Patent Application No. 63/703,305, filed October 4, 2024, which is hereby incorporated by reference in its entirety.

### TECHNICAL FIELD

The present disclosure relates to the field of projected capacitive touch technology for flat panel displays and, more particularly, to capacitive liquid crystal displays.

### BACKGROUND

An LCD (Liquid Crystal Display) is a known type of flat panel display which uses liquid crystals in its primary form of operation. LCDs have a large and varying set of uses for consumers and businesses, as they are commonly found in smartphones, televisions, computer monitors and instrument panels. A projected capacitive touchscreen (PCAP) is a touchscreen display technology that uses a matrix of tiny electrodes under the glass surface. This enables thinner displays and better resolution than technologies that use individual wires attached to each pixel.

### SUMMARY

The manufacturing of standard LCD panels typically includes a process that includes a metal frame which surrounds the perimeter of a plurality of internal LCD components of the LCD panel. There are drawbacks associated with using the metal frame, such as, for example, a decrease in longevity of the LCD panel when exposed to unfavorable environments, reduced visibility and transmittance and an increased number of reflections.

The present disclosure advantageously provides improved LCD panels and methods for making improved LCD panels.

The present disclosure provides improving the manufacturing process of an improved LCD panel through utilizing an optically clear adhesive (OCA) bonding process to create a bonded projective capacitive touch panel. The present disclosure provides a custom method to flatten the front surface of any LCD panel so that an OCA bonding process can be used to bond the LCD to a projected capacitive touch screen.

The traditional bonding process for LCD panels utilizes a metal frame to surround internal components of the LCD panel, which may result in air gaps between the internal components after the metal frame is introduced. The methods and apparatuses of the present disclosure provide for a bonding process used in the manufacturing of LCD panels that incorporates liquid optically clear adhesive bonding, which results an in improved LCD panel. Liquid optically clear adhesive (LOCA) bonding involves bonding layers of the plurality of internal LCD components of the LCD panel, which are stacked-up together, with a liquid adhesive.

Advantageously, the methods and apparatus of the present disclosure incorporate optically clear adhesive bonding, which provides thinner bond lines and results in thinner overall display stack-ups. OCA bonding utilizes a dry firm pressure-sensitive adhesive to join layers together. As part of the bonding process, OCA is laminated to a substrate using pressure to eliminate air gaps from the LCD panel assembly. This process allows for bonding a rigid component to rigid or flexible component as well as bonding flexible components, such as an overlay, to a rigid component.

The bonding process for OCA bonding the plurality of internal LCD components of an LCD panel may include rigid-to-rigid OCA bonding and flexible OCA bonding. Rigid-to-rigid OCA bonding involves utilizes a vacuum chamber to remove all air from between layers of the plurality of internal LCD components, closely adhering two or more rigid components to each other. Flexible OCA bonding involves utilizing a roller to push all the air out from between flexible internal LCD components and a substrate or adherent. Here, the substrate or adherent may either be flexible or rigid and the roller may be a manual roller or an automated in-line rotary precision converting.

The removal and prevention of all air bubbles and/or air gaps aids in maximizing optical clarity, which makes OCA bonding ideal for applications where readability is critical. The methods and apparatus of the present disclosure may further include handling, processing and assembly OCA in Class 100 clean rooms to assure zero foreign object debris (FOD) or contamination. Additionally, depending on the material and application, UV or UV-sensitive environments may be involved.

A method for optically bonding an LCD panel, the method comprising arranging a plurality of internal LCD components to form a layered stack; securing at least one piece of tape to a front side of the layered stack; folding the at least one piece of tape over the perimeter of the layered stack; securing the at least one piece of tape to a rear side of the layered stack; and bonding the layered stack with an optically clear adhesive material.

An optically bonded LCD panel, comprising: a plurality of internal LCD components arranged in a layered stack, comprising a front side and a rear side; an optically clear adhesive; at least one piece of tape; wherein the at least one piece of tape is secured to the front side and the rear side of the plurality of internal LCD components such that the perimeter of the plurality of internal LCD components is covered by the least one piece of tape.

The plurality of internal LCD components may include a touch panel, a cover glass and layered stack, the touch panel bonded via the optically clear adhesive to the cover glass and the layered stack on either side of the touch panel.

### BRIEF DESCRIPTION OF THE DRAWINGS

FIG. 1 shows an exploded view of a standard prior art LCD panel having a metal frame enclosing internal components of the LCD panel.

FIG. 2 shows an exploded view of an LCD panel comprising OCA bonding in accordance with the present disclosure.

FIG. 3A shows a front view of the LCD panel of FIG. 2 in accordance with the present disclosure.

FIG. 3B shows a rear view of the LCD panel of FIG. 2 in accordance with the present disclosure.

FIG. 4 shows an illustrated cross-sectional view of the LCD panel of FIG. 2 in accordance with the present disclosure.

FIG. 5 shows a block diagram of an OCA bonding process for the LCD panel of FIG. 2 in accordance with the present disclosure.

### DETAILED DESCRIPTION

Before the various embodiments are described in further detail, it is to be understood that the invention is not limited to the particular embodiments described. It is also to be understood that the terminology used is for the purpose of describing particular embodiments only, and is not intended to limit the scope of the claims of the present application. It should be noted that the terms, such as “comprising,” “including” or “having,” should be understood as not excluding other elements or steps and the words “a” or “an” should be understood as not excluding plurals of the elements or steps.

In the drawings, although certain descriptions may refer only to certain figures and reference numerals, it should be understood that such descriptions might be equally applicable to like reference numerals in other figures. Additionally, although various features have been shown in different figures for simplicity, it should be readily apparent to one of skill in the art that the various features may be combined without departing from the scope of the present disclosure.

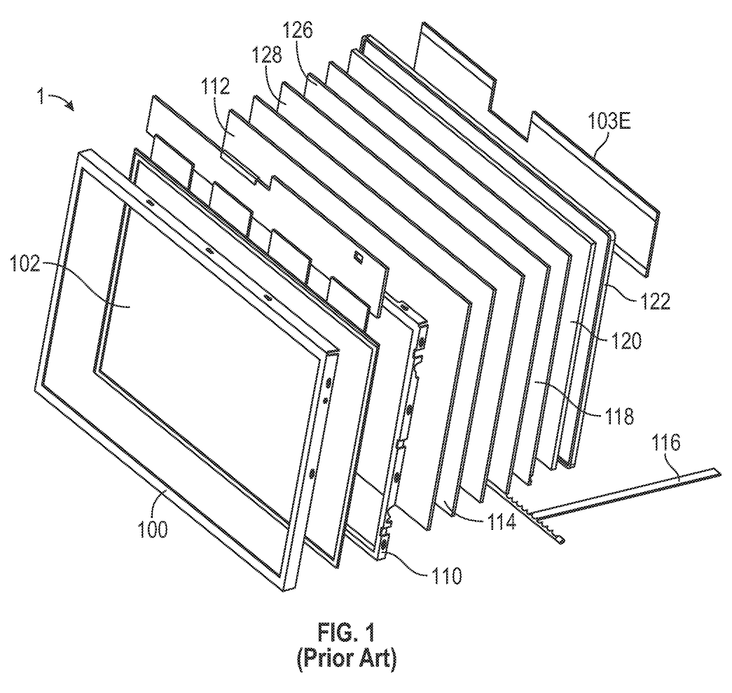

FIG. 1 shows an exploded view of a standard prior art LCD panel 1 having a metal frame 100 enclosing internal components of the panel. The metal frame 100 encloses the flex on board (FOB) 102, making the front of the LCD panel 1 a non-uniform surface. As part of the standard LCD panel manufacturing process, the metal frame 100 also encloses additional internal components shown in layers in the exploded perspective view of FIG. 1. The layered internal components include the flex on board (FOB) printed circuit 102, a housing 110, a UP diffuser film 112, a down prism film 128, a down diffuser film 126, a UP prism film 114, a light bar 116, a light guide 118, a reflector film 120, a back cover 122 and tape 103E secured to the back cover. The structures and functions of these internal components of the LCD panel 1 are standard in the field and, thus, will not be described in further detail herein.

Notably, the metal frame 100 prohibits OCA bonding from occurring because the front surface is not flat. Only liquid optical clear adhesive (LOCA) bonding can be used in the standard process of LCD manufacturing for displays larger than 10.1” since there are many anomalies to the surface caused by the metal frame 100. Generally, OCA bonding is not used for any LCD manufacturing for sizes larger than 10.1”.

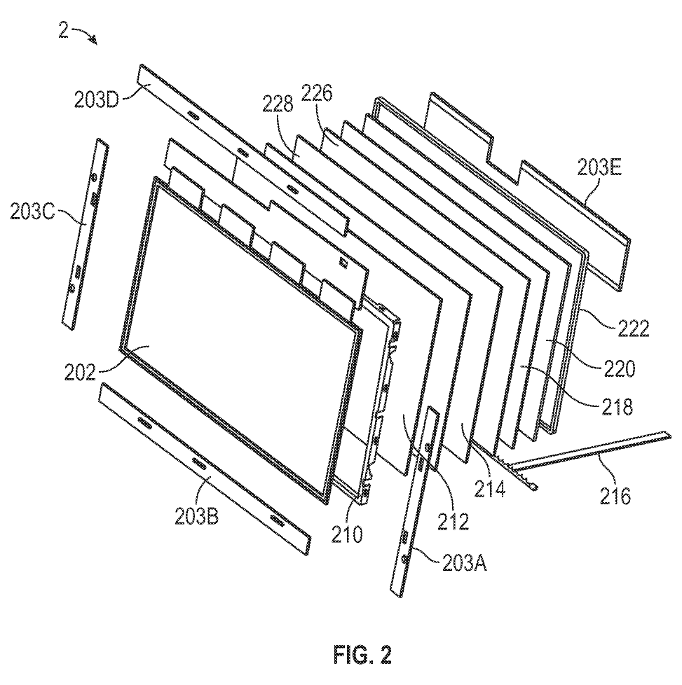

Referring to FIG. 2, an exploded view of an LCD panel 2 according to the present disclosure is shown without the exterior housing or cover glass. The LCD panel 2 includes OCA bonding. The LCD panel 2 does not include a metal frame that standard LCD panels contain, such as the metal frame 100 shown in FIG. 1. Instead of a metal frame, the LCD panel 2 includes one or more tapes (or pieces of tape) 203A-203D that secure and bond internal components of the LCD panel 2. A method for assembling the optically bonded LCD panel 2 may include arranging a plurality of internal LCD components on top of each other in the order shown so as to form a layered stack.

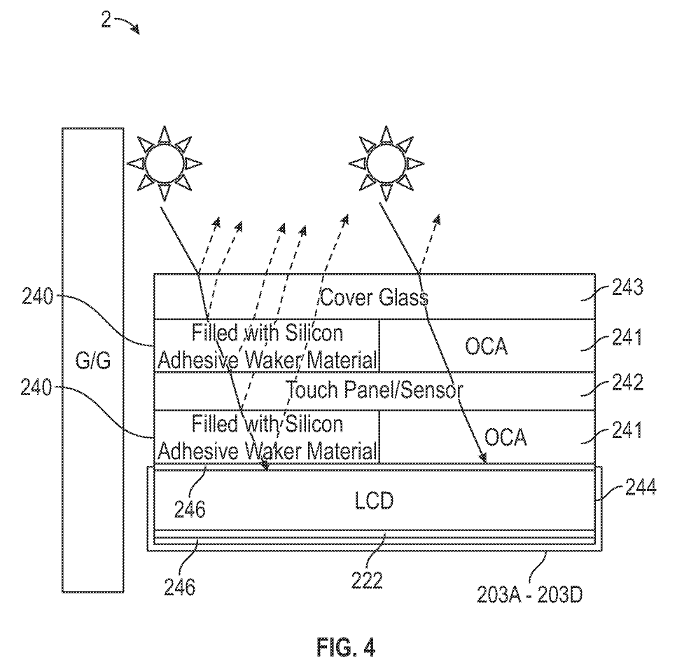

The plurality of internal LCD components forming a layered stack may include a flex on board (FOB) printed circuit (202), a housing 210, a UP diffuser film 212, a down prism film 228, a down diffuser film 226, a UP prism film 214, a light bar 216, a light guide 218, a reflector film 220, a back cover 222 and tape 203E secured to the back cover 222. The LCD panel 2 may also include a cover glass (shown in FIG. 4).

Once the plurality of internal components are assembled and layered as to form a layered stack, at least one piece of tape 203A-203D is secured to the front of the layered stack such that the tape(s) 203A-203D folds over the entire stack of internal components. The at least one piece of tape 203A-203D is then secured to the back cover 222 of the LCD panel 2. The tape 203A-203D is then smoothed out to create a seal. The tape may also be single-sided or double-sided with liners on both sides.

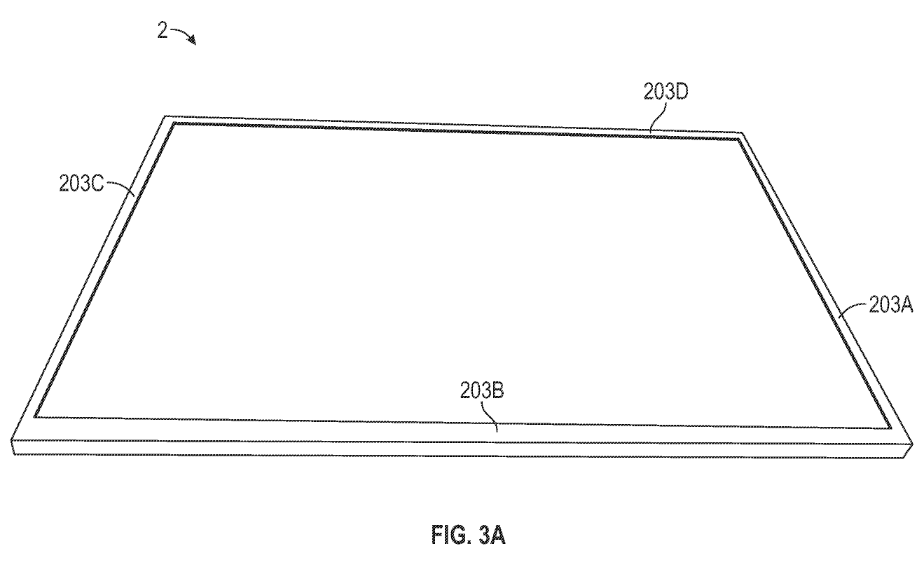

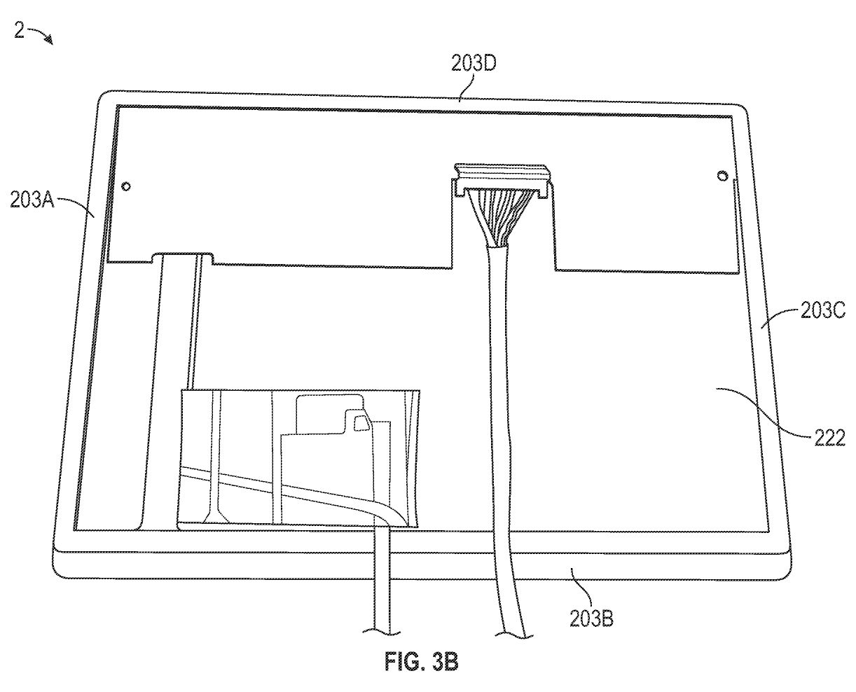

Referring to FIGS. 3A and 3B, the at least one piece of tape 203A-203D is shown wrapped around and covering the perimeter of the front of the LCD panel 2, constituting part of the OCA bonding process. Multiple pieces of tape 203A-203D, including two or more pieces, may be used for OCA bonding the plurality of internal components of the LCD panel 2. In some embodiments, between two and five pieces of tape are used. In some embodiments, a single piece of tape may be used to cover the same area shown with the plurality of pieces of tape 203A-203D. The single piece of tape may span across and bond the entirety of the perimeter of the LCD panel 2. The rear of the LCD panel 2, shown in FIG. 3B, has the tapes 203A-203D folded over the perimeter of the LCD panel 2 such that the tapes 203A-203D extend over the plurality of internal components and are secured to the back cover 222 of the rear side of the LCD panel 2.

Referring to FIG. 4, an illustrated cross-sectional view of the LCD panel 2 including OCA bonding is shown. The at least one piece of tape 203A-203D is shown surrounding the layered stack 244 of internal components. In some embodiments, each tape 203A-203D is .03 mm black mylar tape. However, other types, colors and dimensions of tape are within the scope of the present disclosure.

The layers 246 are each a cap tape that cover a controller board of the LCD panel 2, for example, a black cap tape. The back cover 222 may be made of metal or plastic. The LCD panel 2 includes a cover glass 243 and an optional touch panel/sensor 242, which may be bonded together by the OCA 241 as well as a silicon adhesive waker material 240.

In some embodiments, OCA 241 is bonded first to the touch panel/sensor 242 and the cover glass 243. Next, an additional layer of OCA 241 is bonded to the back of the sensor 242, which is used to bond the sensor 242 to the LCD panel 2. The OCA 241 between the touch panel/sensor 242 and the layered stack 244 may be the same material or composition as OCA 241 between the cover glass 243 and the touch panel/sensor 242, or in other embodiments the OCA 241 materials or compositions may be different. In some embodiments, the OCA is only located in the viewing area of the LCD panel 2. Silicon adhesive waker material 240 may be used to fill the gaps all the around the frame of the LCD panel 2 not within the viewing area, located next to the OCA on both sides of the touch panel/sensor in the cross-sectional view of the panel 2. Mitsubishi CLEARFIT^{®} or a similar OCA may be used as the OCA as part of the OCA bonding process.

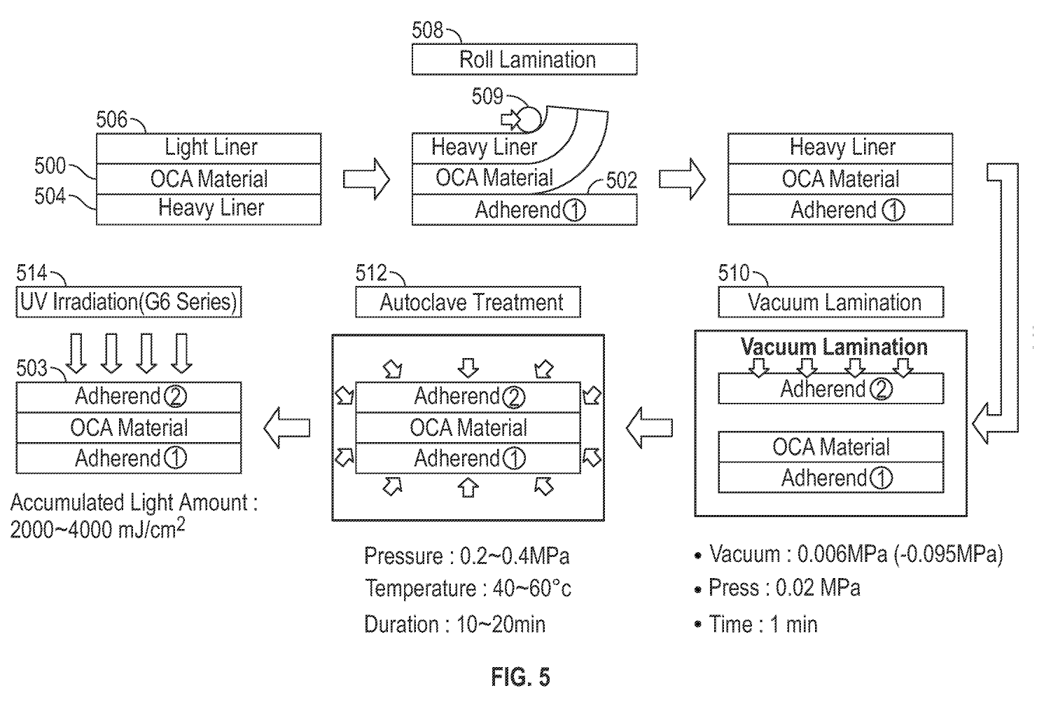

Referring to FIG. 5, a block diagram of an embodiment of the OCA bonding process and LCD panel produced therefrom is shown. In some embodiments, an OCA material 500 equipped with a light liner 506 and heavy liner 504 undergoes roll lamination step 508. Before beginning roll lamination 508, the light liner is discarded from the OCA material 500. Here, a roller 509, which may be a manual roller or automated in-line rotary precision converting, is used to push all the air out from between a first adherend 502 and the heavy liner 504, which allows for the OCA material to bond to the first adherend 502.

After the OCA material 500 is bonded to the first adherend 502, the OCA material under vacuum lamination 510 with a second adherend 503. The vacuum lamination may operate at a pressure of 0.006MPa (-0.095MPa) with a pressing pressure of 0.02 MPa for a time period of one minute. During the vacuum lamination, the second adherend 503 is bonded with the OCA material 500 such that the OCA material is bonded to the first and second adherends 502, 503 on each side of the OCA material 500. Vacuum laminations are known by those in the art and it is within the scope of the present disclosure that the conditions of vacuum lamination can be altered. The first and second adherends 501, 502 may be any of the cover glass, touch panel/sensor or layered stack of internal components but are not limited to these specific elements.

Following vacuum lamination 510, the next step is to apply an autoclave treatment 512. This autoclave treatment 512 may occur at a pressure of roughly 0.2 to 0.4 MPA with a temperature of roughly forty to sixty degrees Celsius for a duration of around ten to twenty minutes. Autoclave treatments are known by those in the art and it is within the scope of the present disclosure that the conditions of the autoclave treatment can be altered. Following the autoclave treatment 512, UV irradiation 514 is applied to the OCA material 500 bonded to the first and second adherends 502, 503. Here, the accumulated light amount may be, for example, around 2,000 to 4,000 mJ/cm².

Vacuum lamination, autoclave treatment and UV irradiation are known in the field and it is within the scope of the present disclosure that the specific conditions of these steps can vary without deviating from the OCA bonding process taught in the present disclosure.

What is claimed is:

1. A method of making a liquid crystal display (LCD) panel, the method comprising:
arranging panel components to form a layered stack;
securing at least one piece of tape to a front side of the layered stack;
folding the at least one piece of tape over a perimeter of the layered stack;
securing the at least one piece of tape to a rear side of the layered stack.

2. The method according to claim 1, wherein the panel components include a flex on board, a housing and a back cover.

3. The method according to claim 1, further comprising bonding the layered stack to a touch panel/sensor with an optically clear adhesive (OCA).

4. The method according to claim 3, wherein the bonding comprises further comprising laminating the optically clear adhesive to a substrate using a roller.

5. The method according to claim 3, further comprising bonding the touch panel/sensor to a cover glass with an optically clear adhesive (OCA).

6. The method according to claim 1, further comprising bonding a cover glass to the layered stack with an optically clear adhesive (OCA).

7. The method according to claim 6, wherein the bonding comprises using a roller to apply the OCA to the cover glass prior to joining the cover glass with the layered stack.

8. The method according to claim 7, wherein the joining comprises using a vacuum.

9. The method according to claim 8, further comprising performing an autoclave treatment on the layered stack and the cover glass.

10. The method according to claim 1, wherein the at least one piece of tape comprises four pieces of tape.

11. A liquid crystal display (LCD) panel comprising:
components arranged in a layered stack, the layered stack having a front side and a rear side;
at least one piece of tape secured to the front side and the rear side of the layered stack and covering a perimeter of the layered stack.

12. The LCD panel according to claim 11, wherein the components comprise a flex on board, a housing and a back cover.

13. The LCD panel according to claim 11, further comprising a cover glass bonded to the layered stack with an optically clear adhesive (OCA).

14. The LCD panel according to claim 13, wherein the OCA is arranged only in a viewing area of the LCD panel.

15. The LCD panel according to claim 13, wherein a silicon adhesive waker material is arranged between the cover glass and the layered stack.

16. The LCD panel according to claim 11, further comprising a touch panel/sensor bonded to the layered stack with an optically cleared adhesive (OCA).

17. The LCD panel according to claim 16, further comprising a cover glass bonded to the touch panel/sensor with an optically clear adhesive (OCA).

18. The optically bonded LCD panel according to claim 13, wherein the optically clear
adhesive is laminated using a manual roller.

19. The optically bonded LCD panel according to claim 13, wherein the optically clear
adhesive is laminated using an automated in-line precision converter.

20. The optically bonded LCD panel according to claim 13, wherein the optically clear
adhesive is vacuum laminated.

21. The optically bonded LCD panel according to claim 8, wherein the at least one piece of
tape comprises two to five pieces of tape.
